(19) United States
(12) Patent Application Publication
(10) Pub. No.: US 2011/0305041 A1
(43) Pub. Date: Dec. 15, 2011

(54) LIGHT GUIDE PLATE STRUCTURE AND BACKLIGHT MODULE USING SAME

(75) Inventor: Sei-Ping LOUH, Tu-Cheng (TW)

(73) Assignee: HON HAI PRECISION INDUSTRY CO., LTD., Tu-Cheng (TW)

(21) Appl. No.: 12/846,801

(22) Filed: Jul. 29, 2010

(30) Foreign Application Priority Data
Jun. 11, 2010 (TW) 99118978

(51) Int. Cl. F21V 7/22

(52) U.S. Cl. 362/614; 362/621; 362/622

(57) ABSTRACT

A guide light plate structure includes a light guide plate and a fluorescent layer. The light guide plate includes a light incident surface, a bottom surface, and a light emitting surface opposite to the bottom surface. The fluorescent layer is formed on the bottom surface. The fluorescent layer is conFIGUREd for being excited by the incident light to emit white light toward the light emitting surface.

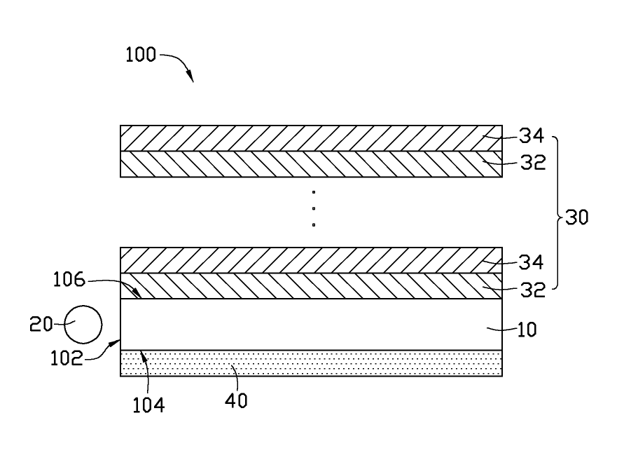

### BACKGROUND

1. Technical Field

The present disclosure relates to light source devices and, particularly, to a light guide plate structure and a related backlight module.

2. Description of Related Art

Generally, a backlight module emitting approximate white light is needed to illuminate a liquid crystal display (LCD) device to display actual images. The backlight module is used to convert linear light sources such as cold cathode ray tubes, or point light sources such as light emitting diodes (LEDs), into area light sources having high uniformity and brightness.

If LEDs are introduced as point light sources to the backlight module; the LEDs usually employ specific phosphor powder packed with light emitting diode chips for emitting the approximate white light. However, since the LEDs usually have an arc-shaped surface, the phosphor powder is distributed non-uniformly such that the approximate white light emitted from the LEDs has a poor uniformity. Thus, the backlight modules employing the LEDs have a poor uniformity.

Therefore, it is desirable to provide a light guide plate structure and a backlight module using the same, which can overcome or at least alleviate the above-mentioned problems.

### BRIEF DESCRIPTION OF THE DRAWINGS

The FIGURE is a schematic view of a backlight module, according to an exemplary embodiment.

### DETAILED DESCRIPTION

Referring to the FIGURE, a backlight module 100, according to an exemplary embodiment, includes a light guide plate 10, a light source 20, a multilayer coating 30, and a fluorescent layer 40. The light guide plate 10, the multilayer coating 30, and the fluorescent layer 40 cooperatively form a light guide plate structure.

The light guide plate 10 is a transparent plate, and may be made of a material selected from a group consisting of polymethyl metharylate, methacrylic resin, polyacrylic ester, polycarbonate, and polythene resin. The light guide plate 10 may be a flat plate or a wedge-shaped plate. In this embodiment, the light guide plate 10 is a flat plate. The light guide plate 10 includes a light incident surface 102, a bottom surface 104, a light emitting surface 106, and three reflective surfaces (not shown). The light emitting surface 106 is opposite to the bottom surface 104. The light incident surface 102 and the three reflective surfaces connect each other end-to-end. The light incident surface 102 and the three reflective surfaces perpendicularly connect the light emitting surface 106 to the bottom surface 104.

The light source 20 is positioned adjacent to the light guide plate 10 and faces the light incident surface 102. The light source 20 is selected from a blue LED, a red LED, a green LED, a purple LED, and an ultraviolet LED. If the light source 20 is a blue LED, the light source 20 emits blue light. If the light source 20 is a red LED, the light source 20 emits red light. If the light source 20 is a green LED, the light source 20 emits green light. If the light source 20 is a purple LED, the light source 20 emits purple light. If the light source 20 is an ultraviolet, the light source emits ultraviolet light. In this embodiment, the light source 20 is a blue LED.

The multilayer coating 30 is formed on the light emitting surface 106 and conFIGUREd for allowing light with a wavelength in the range from about 400 nanometers to about 700 nanometers to pass therethrough and reflect light with a wavelength of less than about 400 nanometers or greater than about 700 nanometers. The multilayer coating 30 includes a plurality of high refraction index films 32 and a plurality of low refraction index films 34 alternately stacked one on another. In this embodiment, the high refraction index film 32 is a TiO₂ (titanium dioxide) film or a Ta₂O₅ (tantalum pentoxide) film. The low refraction index film 34 is a SiO₂ (silicon dioxide) film. The total number of layers of the low refraction index films and the high refraction index films is less than or equal to 20, and the physical thickness of the multilayer coating 30 is less than about 0.5 millimeters.

A vacuum deposition method, a plasma deposition method, a sputtering-coating deposition, an ink jet method, or a screen printing method may be used to deposit the multilayer coating 30 on the light emitting surface 106. In this embodiment, the multilayer coating 30 is coated on the light emitting surface 106 by the vacuum deposition method.

The fluorescent layer 40 may be a layer comprised of phosphor powder. The phosphor powder of the fluorescent layer 40 is selected according to the light source 20. In particular, the fluorescent layer 40 is comprised of yellow phosphor powder, if the light source 20 is a blue LED. The material of the yellow phosphor powder includes Y₃Al₅O₁₂:Ce³⁺ (cerium-doped yttrium aluminium garnet). The light source 20 is conFIGUREd for emitting blue light. Parts of the blue light excites the fluorescent layer 40 to emit yellow light, and other parts of the blue light is mixed with the excited yellow light to form the white light.

In other embodiment, the fluorescent layer 40 is comprised of red phosphor powder, green phosphor powder, and blue phosphor powder, if the light source 20 is an ultraviolet LED. The material of the red phosphor powder may be Y₂O₃:Eu²⁺, YBO₃:EU³⁺, or GdBO₃:Eu³⁺. The material of the green phosphor powder may be Zn₂SiO₄:Mn²⁺, ZnSiOₓ:Mn²⁺, or Mn²⁺ aluminate, wherein x is 1 or 2. The material of the blue phosphor powder may be BaMgAlOₓ₁:Eu²⁺, CaMgSiOₓ₂:Eu²⁺, BaMgAl₁₀O₁₇:Eu²⁺, or Eu²⁺ aluminate, wherein x1 is 1, 2 or 3, and x2 is 1 or 2. The light source 20 emits ultraviolet light to excite the fluorescent layer 40 to emit the white light.

In operation, blue light emitting from the light source 20 enters into the guide light plate 10 from the light incident surface 102. Parts of the blue light excites the fluorescent layer 40 to emit the yellow light, other parts of the blue light is mixed with the excited yellow light to form the white light. The white light passes through the light emitting surface 106 uniformly. Additionally, the multilayer coating 30 can diffuse the white light and enlarge the field of illumination of the white light.

It is to be understood, however, that even though numerous characteristics and advantages of the present embodiments have been set fourth in the foregoing description, together with details of the structures and functions of the embodiments, the disclosure is illustrative only, and changes may be made in details, especially in matters of shape, size, and arrangement of parts within the principles of the disclosure to the full extent indicated by the broad general meaning of the terms in which the appended claims are expressed.

What is claimed is:

1. A guide light plate structure, comprising:
a light guide plate comprising a light incident surface, a bottom surface, and a light emitting surface opposite to the bottom surface;
a fluorescent layer formed on the bottom surface, the fluorescent layer conFIGUREd for being excited by incident light to emit white light toward the light emitting surface.

2. The guide light plate structure as claimed in claim 1, further comprising a multilayer coating, wherein the multilayer coating is formed on the light emitting surface, the multilayer coating is conFIGUREd for allowing light with a wavelength in the range from 400 nanometers to 700 nanometers to pass therethrough and reflecting light with a wavelength of less than 400 nanometers or greater than 700 nanometers.

3. The guide light plate structure as claimed in claim 2, wherein the multilayer coating comprises a plurality of high refraction index films and a plurality of low refraction index films alternately stacked one on another.

4. The guide light plate structure as claimed in claim 3, wherein the high refraction index film is a titanium dioxide film or a tantalum pentoxide film, and the low refraction index film is a silicon dioxide film.

5. The guide light plate structure as claimed in claim 4, wherein the total number of layers of the low refraction index films and high refraction index films is less than or equal to 20, and the physical thickness of the multilayer coating is less than 0.5 millimeters.

6. The guide light plate structure as claimed in claim 1, wherein the fluorescent layer is comprised of yellow phosphor powder.

7. The guide light plate structure as claimed in claim 6, wherein the material of the yellow phosphor power comprises Y₃Al₅O₁₂:Ce³⁺.

8. The guide light plate structure as claimed in claim 1, wherein the fluorescent layer is comprised of red phosphor powder, green phosphor powder, and blue phosphor powder.

9. The guide light plate structure as claimed in claim 8, wherein the material of the red phosphor powder is Y₂O₃:Eu²⁺, YBO₃:EU³⁺, or GdBO₃:Eu³⁺, the material of the green phosphor powder is Zn₂SiO₄:Mn²⁺, ZnSiOₓ:Mn²⁺, or Mn²⁺ aluminate, wherein x is 1 or 2; and the material of the blue phosphor powder is BaMgAlOₓ₁:Eu²⁺, CaMgSiOₓ₂:Eu²⁺, BaMgAl₁O₁₇:Eu²⁺, or Eu²⁺ aluminate, wherein x₁ is 1, 2 or 3, and x₂ is 1 or 2.

10. A backlight module, comprising:
a light guide plate comprising a light incident surface, a bottom surface, and a light emitting surface opposite to the bottom surface;
a light source facing the light incident surface;
a fluorescent layer formed on the bottom surface, the fluorescent layer conFIGUREd for being excited by light from the light source to emit white light toward the light emitting surface.

11. The backlight module as claimed in claim 10, further comprising a multilayer coating, wherein the multilayer coating is formed on the light emitting surface, the multilayer coating is conFIGUREd for allowing light with a wavelength in the range from 400 nanometers to 700 nanometers to pass therethrough and reflecting light with a wavelength of less than 400 nanometers or greater than 700 nanometers.

12. The backlight module as claimed in claim 11, wherein the multilayer coating comprises a plurality of high refraction index films and a plurality of low refraction index films that alternately stacked one to another.

13. The backlight module as claimed in claim 12, wherein the high refraction index film is a titanium dioxide film or a tantalum pentoxide film, and the low refraction index film is a silicon dioxide film.

14. The backlight module as claimed in claim 13, wherein the total number of layers of the low refraction index films and high refraction index films is less than or equal to 20, and the physical thickness of the multilayer coating is less than 0.5 millimeters.

15. The backlight module as claimed in claim 14, wherein the fluorescent layer is comprised of yellow phosphor powder.

16. The backlight module as claimed in claim 15, wherein the material of the yellow phosphor powder comprises Y₃Al₅O₁₂:Ce³⁺.

17. The backlight module as claimed in claim 14, wherein the fluorescent layer is comprised of red phosphor powder, green phosphor powder, and blue phosphor powder.

18. The backlight module as claimed in claim 17, wherein the material of the red phosphor powder is Y₂O₃:Eu²⁺, YBO₃:EU³⁺, or GdBO₃:Eu³⁺, the material of the green phosphor powder is Zn₂SiO₄:Mn²⁺, ZnSiOₓ:Mn²⁺, or Mn²⁺ aluminate, wherein x is 1 or 2; and the material of the blue phosphor powder is BaMgAlOₓ₁:Eu²⁺, CaMgSiOₓ₂:Eu²⁺, BaMgAl₁₀O₁₇:Eu²⁺, or Eu²⁺ aluminate, wherein x1 is 1, 2 or 3, and x2 is 1 or 2.
